(19) United States
(12) Patent Application Publication
(10) Pub. No.: US 2016/0029419 A1
(43) Pub. Date: Jan. 28, 2016

(54) METHODS AND DEVICES FOR CONNECTING TO WIRELESS NETWORK

(71) Applicant: Xiaomi Inc., Beijing (CN)

(72) Inventors: Shen Li, Beijing (CN); Heng Wang, Beijing (CN); Fei Xiangli, Beijing (CN)

(73) Assignee: Xiaomi Inc.

(21) Appl. No.: 14/620,730

(22) Filed: Feb. 12, 2015

Related U.S. Application Data
(63) Continuation of application No. PCT/CN2014/091574, filed on Nov. 19, 2014.

(30) Foreign Application Priority Data
Jul. 25, 2014 (CN) 201410360907.9

(51) Int. Cl. H04W 76/02; H04W 48/16

(52) U.S. Cl. CPC H04W 76/021; H04W 48/16

(57) ABSTRACT

A method for a device to connect to a wireless network is provided. The method includes: detecting a first wireless network when a wireless network connection of the device is in a disconnected state, wherein the first wireless network has a same name as a second wireless network, and connection information for connecting to the second wireless network is pre-stored in the device; generating a first wireless network list including one or more wireless networks detected when the first wireless network is detected; comparing the first wireless network list with a pre-stored second wireless network list to obtain a comparing result, wherein the second wireless network list includes one or more wireless networks previously detected when the device was connected to the second wireless network; and if the comparing result satisfies a preset condition, sending a connection request to the first wireless network.

### CROSS-REFERENCE TO RELATED APPLICATIONS

This application is a continuation of International Application No. PCT/CN2014/091574, filed Nov. 19, 2014, which is based upon and claims priority to Chinese Patent Application No. CN201410360907.9, filed Jul. 25, 2014, the entire contents of all of which are incorporated herein by reference.

### TECHNICAL FIELD

The present disclosure generally relates to the field of communication technology and, more particularly, to methods and devices for connecting to a wireless network.

### BACKGROUND

Conventionally, a terminal device may be capable of storing a name and a password of a wireless network to which the terminal device has previously connected, so that automatic connection can be performed using the stored password when the wireless network is detected for a next time. The wireless network includes for example, a Wireless Fidelity (WiFi) network and various networks based on the Institute of Electrical and Electronic Engineers (IEEE) 802.11 protocol. When performing automatic connection using a stored password, it is generally required for the terminal device to determine whether a currently detected wireless network is the same as the previously connected wireless network. For example, the terminal device may check whether names of the two wireless networks are the same and, if they are the same, determine that the currently detected wireless network is the same as the previously connected wireless network.

### SUMMARY

According to a first aspect of the present disclosure, there is provided a method for a device to connect to a wireless network, comprising: detecting a first wireless network when a wireless network connection of the device is in a disconnected state, wherein the first wireless network has a same name as a second wireless network, and connection information for connecting to the second wireless network is pre-stored in the device; generating a first wireless network list including one or more wireless networks detected when the first wireless network is detected; comparing the first wireless network list with a pre-stored second wireless network list to obtain a comparing result, wherein the second wireless network list includes one or more wireless networks previously detected when the device was connected to the second wireless network; and if the comparing result satisfies a preset condition, sending a connection request to the first wireless network based on the connection information for connecting to the second wireless network.

According to a second aspect of the present disclosure, there is provided a device for connecting to a wireless network, comprising: a processor; and a memory for storing instructions executable by the processor. The processor is configured to: detect a first wireless network when a wireless network connection of the device is in a disconnected state, wherein the first wireless network has a same name as a second wireless network, and connection information for connecting to the second wireless network is pre-stored in the device; generate a first wireless network list including one or more wireless networks detected when the first wireless network is detected; compare the first wireless network list with a pre-stored second wireless network list to obtain a comparing result, wherein the second wireless network list includes one or more wireless networks previously detected when the device was connected to the second wireless network; and if the comparing result satisfies a preset condition, send a connection request to the first wireless network based on the connection information for connecting to the second wireless network.

According to a third aspect of the present disclosure, there is provided a non-transitory computer-readable medium having stored therein instructions that, when executed by a processor of a device, cause the device to perform a method for connecting to a wireless network, the method comprising: detecting a first wireless network when a wireless network connection of the device is in a disconnected state, wherein the first wireless network has a same name as a second wireless network, and connection information for connecting to the second wireless network is pre-stored; generating a first wireless network list including one or more wireless networks detected when the first wireless network is detected; comparing the first wireless network list with a pre-stored second wireless network list to obtain a comparing result, wherein the second wireless network list includes one or more wireless networks previously detected when the device was connected to the second wireless network; and if the comparing result satisfies a preset condition, sending a connection request to the first wireless network based on the connection information for connecting to the second wireless network.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for automatically connecting to a wireless network, according to an exemplary embodiment.

FIG. 2 is a flowchart of a method for automatically connecting to a wireless network, according to an exemplary embodiment.

FIG. 3 is a flowchart of a method for automatically connecting to a wireless network, according to an exemplary embodiment.

FIG. 4 is a block diagram of an apparatus for automatically connecting to a wireless network, according to an exemplary embodiment.

FIG. 5 is a block diagram of an apparatus for automatically connecting to a wireless network, according to an exemplary embodiment.

FIG. 6A is a block diagram of an apparatus for automatically connecting to a wireless network, according to an exemplary embodiment.

FIG. 6B is a block diagram of an apparatus for automatically connecting to a wireless network, according to an exemplary embodiment.

FIG. 7 is a block diagram of an apparatus for automatically connecting to a wireless network, according to an exemplary embodiment.

FIG. 8A is a block diagram of an apparatus for automatically connecting to a wireless network, according to an exemplary embodiment.

FIG. 8B is a block diagram of an apparatus for automatically connecting to a wireless network, according to an exemplary embodiment.

FIG. 9 is a block diagram of a terminal device, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

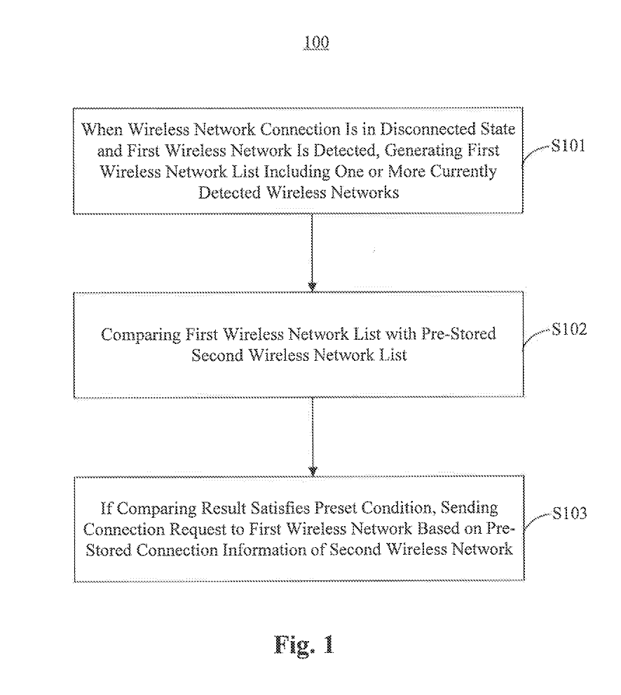

FIG. 1 is a flowchart of a method 100 for automatically connecting to a wireless network, according to an exemplary embodiment. For example, the method 100 may be used in a terminal device, such as a cell phone, a tablet computer, a laptop computer, etc. Referring to FIG. 1, the method 100 includes the following steps.

in step S101, when the terminal device's wireless network connection is in a disconnected state and a first wireless network is detected, the terminal device generates a first wireless network list including one or more currently detected wireless networks. For example, the first wireless network list may be generated based on names of the currently detected wireless networks. In the illustrated embodiment, the first wireless network has a same name with a second wireless network, and connection information of the second wireless network is already stored in the terminal device.

In step S102, the terminal device compares the first wireless network list with a pre-stored second wireless network list to obtain a comparing result. The second wireless network list is a list of wireless networks previously detected when the terminal device was previously connected to the second wireless network.

In some embodiments, the second wireless network list may be generated by searching names of available wireless networks when the second wireless network is connected.

For example, if a currently detected first wireless network has a name of D and a wireless network with the same name has been connected previously, the wireless network which has the same name D and has been connected previously is the second wireless network, whose connection information has been pre-stored in the terminal device. The names of available wireless networks are searched when the second wireless network is connected. A second wireless network list corresponding to the second wireless network is generated based on the names of available wireless networks, and is identified as e.g., ListD2. The first wireless network list is identified as, e.g., ListD1. In step S102, the lists ListD1 and ListD2 are compared to obtain a comparing result with respect to the second wireless network.

In some embodiments, step S102 may include steps A1-A2 described below.

In step A1, the terminal device determines a number of items in the first wireless network list that each have a same name as one of those in the second wireless network list, where each item corresponds to a wireless network.

In step A2, the terminal device determines a ratio of the number of items in the first wireless network list that each have a same name as one of those in the second wireless network list to a total number of items in the second wireless network list, and use the determined ratio as a comparing result with respect to the second wireless network.

By counting a number of items in the first wireless network list that each have a same name as an item in the second wireless network list, the comparing result can reflect a matching degree of the two wireless network lists, thereby improving the accuracy in subsequent determination of same wireless networks and reducing the chance of unsuccessful automatic connection.

In other embodiments, the terminal device may determine a number of items in the first wireless network list that each have a same name as one of those in the stored second wireless network list, and use the determined number of items to obtain a comparing result with respect to the second wireless network.

In step S103, if the comparing result satisfies a preset condition, the terminal device sends a connection request to the first wireless network based on the pre-stored connection information of the second wireless network.

In some embodiments, if the determine ratio obtained from the comparing step S102 is greater than a preset ratio, the terminal device may determine that the comparing result satisfies the preset condition.

For instance, the first and second wireless network lists are identified as lists ListD1 and ListD2, respectively. The lists ListD1 and ListD2 have 7 common items, and the list ListD2 has a total item number of 10. It can be determined that the comparing result of the list ListD2 is 70% after comparing the two lists. If the preset ratio is 60%, since the comparing result of 70% is greater than this preset ratio, the terminal device may determine that the comparing result satisfies the preset condition.

In some embodiments, there may be at least two second wireless networks, each of which has a same name as that of the first wireless network. The terminal device may send connection requests to each of the second wireless networks if the corresponding comparing result for each of the second wireless networks satisfies the preset condition. The connection requests may be sent in a sequential order until connection to the first wireless network succeeds or the connection information of each of the second wireless networks has been used.

In some embodiments, the terminal device may sort the second wireless networks whose comparing results satisfy the preset condition in a descending order, and send connection requests to the first wireless network by using connection information of the second wireless networks according to the sorted order, until connection to the first wireless network succeeds or the connection information of each of the second wireless networks has been used.

In some embodiments, when there are at least two second wireless networks and corresponding second wireless network lists, the terminal device may compare the first wireless network list with one of the second wireless network lists to obtain a comparing result. If the comparing result satisfies the preset condition, the terminal device may send a connection request the first wireless network based on connection information of the second wireless network corresponding to the compared second wireless network list, if the comparing result does not satisfy the preset condition, the terminal device may compare the first wireless network list with a next second wireless network list, and this operation may be repeated until connection to the first wireless network succeeds or all of the second wireless network lists are compared.

In some embodiments, the second wireless network list may be updated using the first wireless network list if a connection to the first wireless network succeeds after the connection request is sent. For example, each item of the first wireless network list which is not included in the second wireless network list, may be added into the second wireless network list.

For instance, in the above example, the list ListD2 is the second wireless network list, and the list ListD1 is the first wireless network list. Each item in the list ListD1 which is not included in the list ListD2, may be added into the list ListD2. Thus, the stored list ListD2 may be improved, and subsequent comparing results obtained by using the improved list ListD2 may be more accurate, thereby increasing the accuracy for determining whether there is a same wireless network and reducing the chance of unsuccessful automatic connection.

In some embodiments, the second wireless network list may be replaced with the first wireless network list. By replacing the second wireless network list with the first wireless network list, the stored first wireless network list can be updated in real time.

In some embodiments, the terminal device may store the first wireless network list when the comparing result does not satisfy the preset condition, and the stored first wireless network list may be used in subsequent operations.

For instance, when the comparing result does not satisfy the preset condition in step S103, an automatic connection operation will not be started, and the terminal device may pop up a prompting box to prompt user input of the connection password. When a connection to the first wireless network using the connection password succeeds, the stored first wireless network list may be changed into a second wireless network list. When the connection to the first wireless network using the connection password fails, the stored first wireless network list is a wireless network list to be confirmed, and the currently detected first wireless network is a wireless network to be confirmed. When a wireless network detected at a later time has the same name with the above mentioned wireless network to be confirmed, the wireless network list to be confirmed is compared with the wireless network list of the wireless network detected at the later time. When the comparing result satisfies the preset condition, an automatic connection will not be started, and the terminal device may pop up a prompting box to prompt input of the connection password. When a connection to the wireless network detected at the later time using the connection password succeeds, the wireless network list to be confirmed is changed into a second wireless network list, and the wireless network to be confirmed becomes a second wireless network, with the input connection password stored as connection information. In addition, the above mentioned wireless network list to be confirmed may be updated based on a wireless network list of the wireless network detected at the later time.

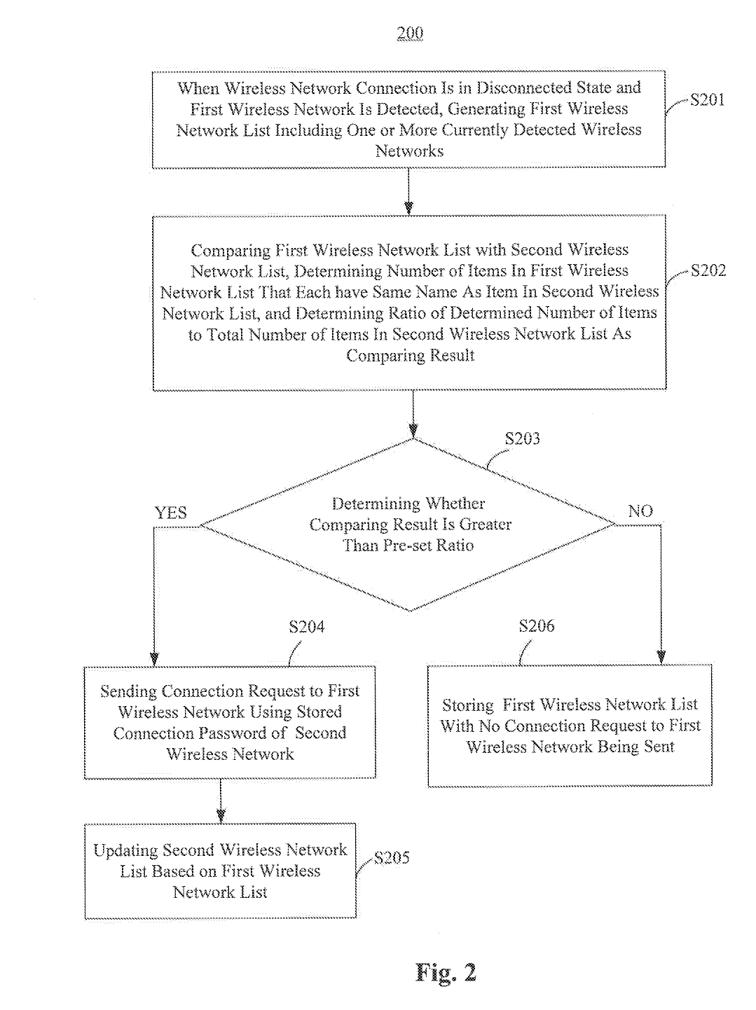

FIG. 2 is a flowchart of a method 200 for automatically connecting to a wireless network, according to an exemplary embodiment. In the illustrated embodiment, the terminal device was previously successfully connected to a second wireless network named A and identified as WIFI A. When the second wireless network was previously connected, a second wireless network list ListA2 was established based on the names of detected wireless networks. For example, the second wireless network list ListA2 may include 5 wireless networks, namely, WIFI A, WIFI B, WIFI C, WIFI D and WIFI E. As a result, for example, the terminal device pre-stores the name WIFI A of the second wireless network, the connection password of WIFI A, and the second wireless network list ListA2, Referring to FIG. 2, the method 200 includes the following steps.

In step S201, when the terminal device's wireless network connection is in a disconnected state and a first wireless network, such as a wireless network named A is detected, the terminal device generates a first wireless network list, such as a wireless network list ListA1, including one or more currently detected wireless networks. For example, the first wireless network list may be generated based on names of the currently detected wireless networks.

In step S202, the terminal device compares the first wireless network list ListA1 with the second wireless network list ListA2, determines a number of items in the first wireless network list ListA1 that each have a same name as an item in the second wireless network list ListA2, and determines a ratio of the determined number of items to the total number of items in the second wireless network list ListA2 as the comparing result.

In step S203, the terminal device determines whether the comparing result is greater than a pre-set ratio, such as a ratio of 60%. If it is greater than the pre-set ratio, step S204 will be performed. If it is less than or equal to the pre-set ratio, step S206 will be performed.

In step S204, the terminal device sends a connection request to the first wireless network using the stored connection password of the second wireless network, i.e. WIFI A in this example.

In step S205, the terminal device updates the second wireless network list ListA2 based on the first wireless network list ListA1.

In step S206, if the determined ratio is less than the pre-set proportion of 60%, the terminal device stores the first wireless network list, i.e., ListA1 in this example, with no connection request being sent to the first wireless network.

By comparing wireless network lists of wireless networks having the same name and performing automatic connection based on the comparing result, the method 200 improves the accuracy of determining whether a previously connected wireless network is the same as a currently detected wireless network, avoids incorrect determination of different wireless networks having the same name as the same wireless network, and reduces the chance of unsuccessful automatic connection.

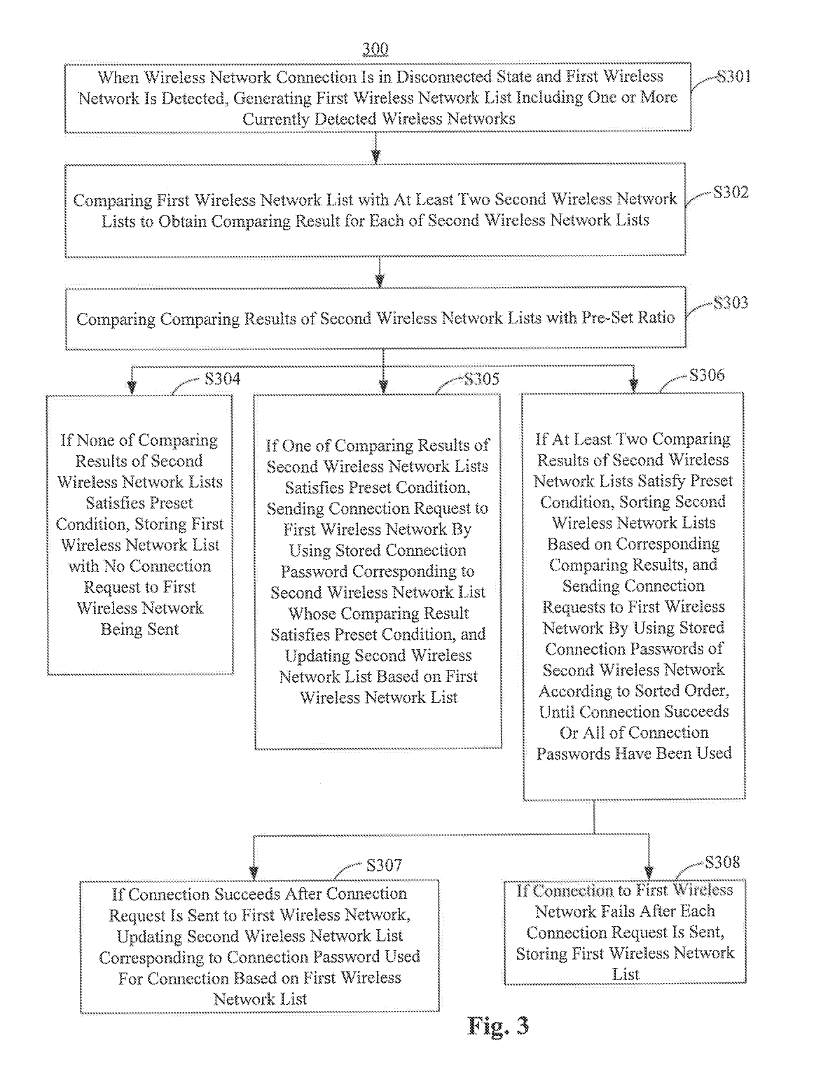

FIG. 3 is a flowchart of a method 300 for automatically connecting to a wireless network, according to an exemplary embodiment. In the illustrated embodiment, the terminal device has pre-stored at least two connection passwords corresponding to a wireless network name B, for example. PasswordB1 and PasswordB2. The terminal device has also pre-stored at least two second wireless network lists, such as a second wireless network list ListB2 corresponding to the connection password PasswordB1 and a second wireless network list ListB22 corresponding to the connection password PasswordB2. Referring to FIG. 3, the method 300 includes the following operations.

In step S301, when the terminal device's wireless network connection is in a disconnected state and a first wireless network, such as a wireless network named B, is detected, the terminal device generates a first wireless network list, such as a wireless network list ListB1, including one or more currently detected wireless networks. For example, the first wireless network list may be generated based on names of the currently detected wireless networks.

In step S302, the terminal device compares the first wireless network list ListB1 with each of the second wireless network lists, such as ListB21 and ListB22, to obtain the respective comparing results of the second wireless network lists.

The comparing result of the respective second wireless network list, such as ListB21 or ListB22, may be a ratio of the number of items in the first wireless network list which has a same name as one of those in the respective second wireless network list to a total number of items in the respective second wireless network list.

In step S303, the terminal device compares the comparing results of the second. wireless network lists, such as ListB21 and ListB22, with a pre-set ratio, such as a ratio of 60%.

In step S304, if none of the comparing results of the second wireless network lists satisfies a preset condition, the terminal device stores the first wireless network list with no connection request being sent to the first wireless network.

In step S305, if one of the comparing results of the second wireless network lists, such as one of ListB21 and ListB22, satisfies the preset condition, the terminal device sends a connection request to the first wireless network by using the stored connection password corresponding to the second wireless network list whose comparing result satisfies the preset condition, and updates the second wireless network list based on the first wireless network list.

For example, if the comparing result of the second wireless network list ListB21 satisfies the preset condition, in step S305, a connection request is sent to the first wireless network by using the stored connection password PasswordB1 corresponding to the second wireless network list ListB21, and the second wireless network list ListB21 is updated based on the first wireless network list ListB1.

In step S306, if at least two comparing results of the second wireless network lists, such as both ListB21 and ListB22, satisfy the preset condition, the second wireless network lists are sorted based on the comparing results in a descending order. Connection requests are sent to the first wireless network in a sequential order by using the stored connection passwords of the second wireless network according to the sorted order of the second wireless network lists, until connection to the first wireless network succeeds or all of the connection passwords have been used.

For instance, the comparing results of the second wireless network lists ListB21 and ListB22 obtained in step S302 are 80% and 70%, respectively. The second wireless network lists ListB21 and ListB22 are sorted such that the corresponding comparing results are arranged in a descending order, i.e., ListB21 and ListB22. The terminal device first sends a connection request to the first wireless network by using the connection password PasswordB1 corresponding to the second wireless network list ListB21. If the connection to the first wireless network succeeds, step S307 will be performed. If it fails, the terminal device next sends a connection request to the first wireless network by using the connection password PasswordB2 corresponding to the second wireless network list ListB22.

In step S307, if a connection to the first wireless network succeeds after the connection request is sent, the terminal device updates the second wireless network list corresponding to the connection password used for the connection based on the first wireless network list ListB1.

In step S308, if a connection to the first wireless network fails after each connection request is sent, the terminal device stores the first wireless network list ListB1.

By comparing wireless network lists of wireless networks having the same name and performing automatic connection based on the comparing result, the method 300 improves the accuracy of determining whether a previously connected wireless network is the same as the currently detected one, avoids incorrect determination of different wireless networks having the same name as the same wireless network, and reduces the chance of unsuccessful automatic connection.

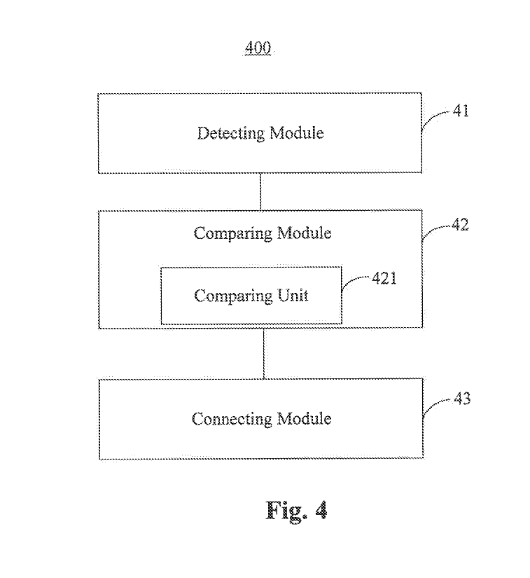

FIG. 4 is a block diagram of an apparatus 400 for automatically connecting to a wireless network, according to an exemplary embodiment. As shown in FIG. 4, the apparatus 400 includes a detecting module 41, a comparing module 42, and a connecting module 43.

The detecting module 41 is configured to generate a first wireless network list including one or more currently detected wireless networks when the wireless network connection is in a disconnected state and a first wireless network is detected. The first wireless network has a same name with a second wireless network with respect to which connection information is pre-stored.

The comparing module 42 is configured to compare the first wireless network list with a pre-stored second wireless network list to obtain a comparing result, where the second wireless network list is a list of detected wireless networks when the second wireless network was connected. The comparing module 42 may include a comparing unit 421. The comparing unit 421 is configured to determine a number of items in the first wireless network list which has a same name as one of those in the second wireless network list, and determine a ratio of the number of items in the first wireless network list which has the same name as one of those in the second wireless network list to a total number of items in the second wireless network list as the comparing result with respect to the second wireless network.

The connecting module 43 is configured to send a connection request to the first wireless network based on the pre-stored connection information of the second wireless network, when the comparing result satisfies a preset condition.

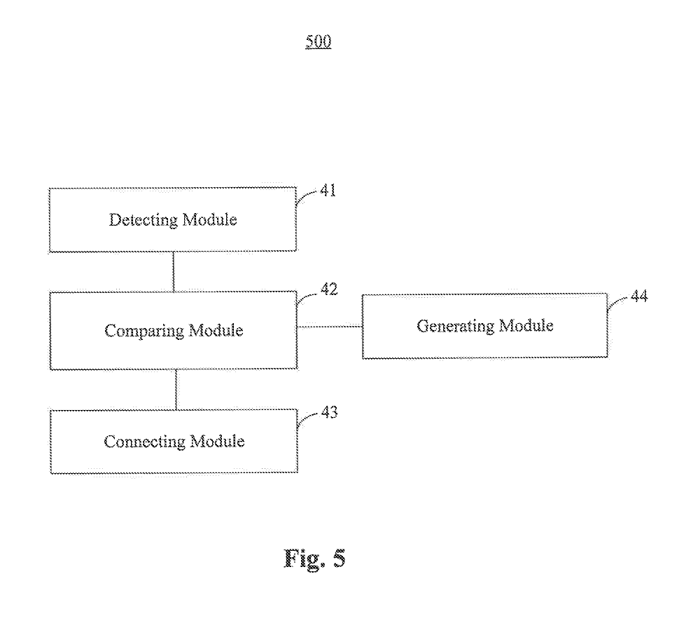

FIG. 5 is a block diagram of an apparatus 500 for automatically connecting to a wireless network, according to an exemplary embodiment. As shown in FIG. 5, the apparatus 500 further includes a generating module 44 in addition to the detecting module 41, the comparing module 42, and the connecting module 43 (FIG. 4). The generating module 44 is configured to detect one or more wireless networks, such as names of available wireless networks, when the second wireless network is connected, and to generate a second wireless network list corresponding to the second wireless network based on the detected wireless networks.

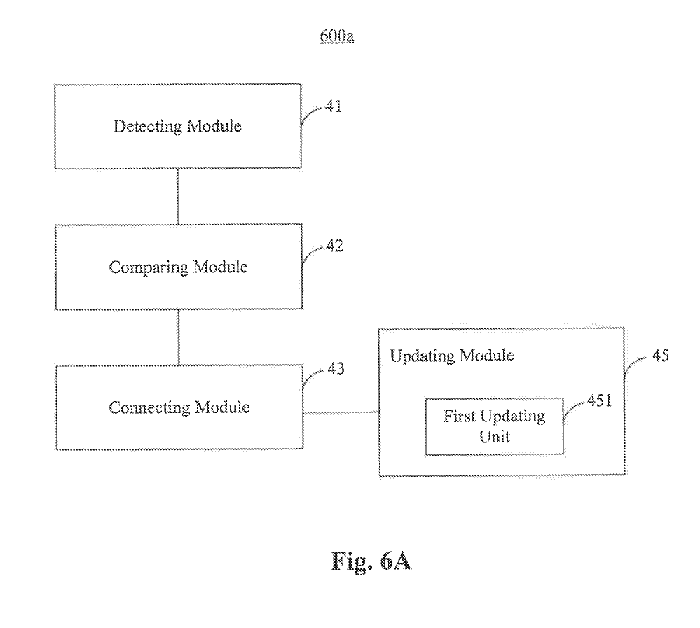

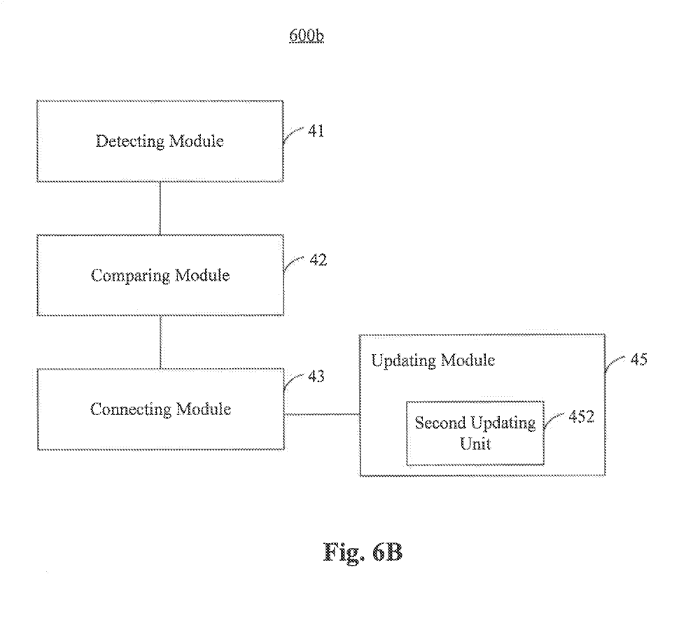

In another embodiment, shown in FIGS. 6A and 6B, apparatuses 600a and 600b may each include an updating module 45. The updating module 45 is configured to update the second wireless network list based on the first wireless network list, if a connection succeeds after the connection request is sent to the first wireless network.

As shown in FIG. 6A, the updating module 45 may include a first updating unit 451 configured to add each item of the first wireless network list which is not included in the second wireless network list, into the second wireless network list. In another embodiment, as shown in FIG. 6B, the updating module 45 may include a second updating unit 452 configured to replace the second wireless network list with the first wireless network list.

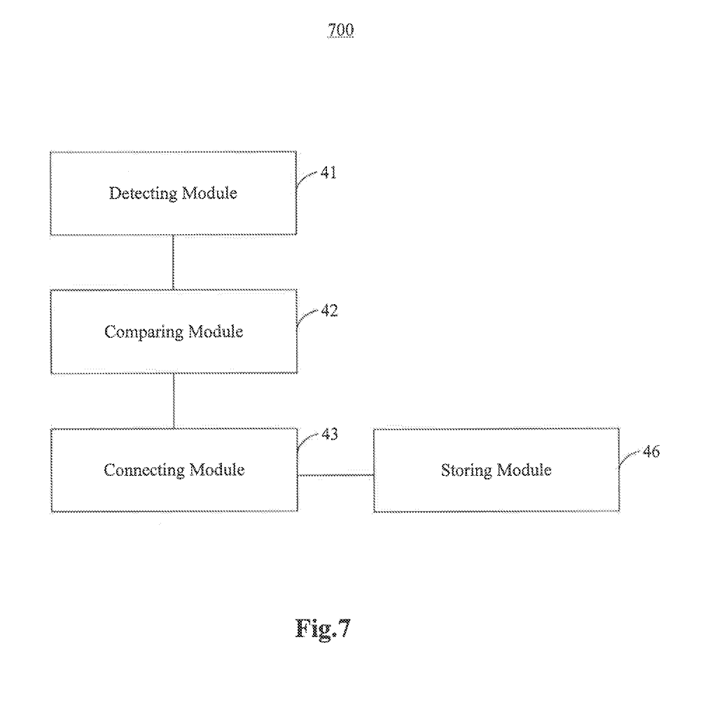

FIG. 7 is a block diagram of an apparatus 700 for automatically connecting to a wireless network, according to an exemplary embodiment. As shown in FIG. 7, the apparatus 700 may include a storing module 46 in addition to the detecting module 41, the comparing module 42, and the connecting module 43 (FIG. 4). The storing module 46 is configured to store the first wireless network list when the comparing result does not satisfy the preset condition.

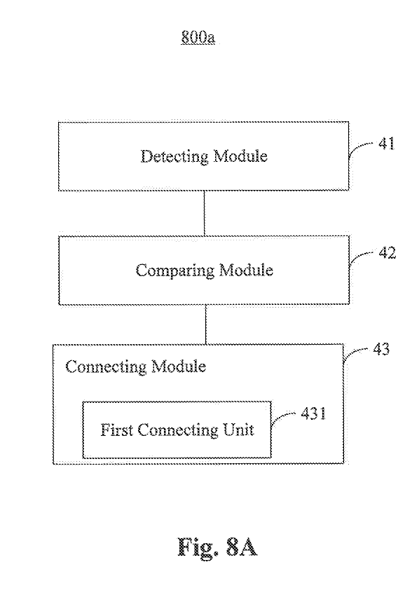

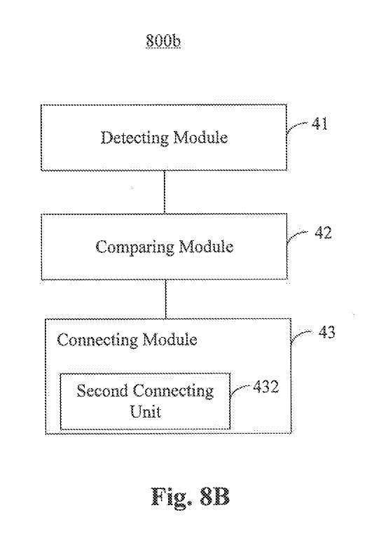

In another embodiment, shown in FIG. 8A, the connecting module 43 of an apparatus 800a may include a first connecting unit 431. The first connecting unit 431 is configured to, when comparing results of at least two second wireless networks satisfy the preset condition, send connection requests to the first wireless network based on pre-stored connection information of the second wireless networks in a sequential order until connection to the first wireless network succeeds or the connection information of all of the second wireless networks have been used. In another embodiment, shown in FIG. 8B, the connecting module 43 of an apparatus 800b may include a second connecting unit 432. The second connecting unit 432 is configured to, when comparing results of at least two second wireless networks satisfy the preset condition, sort the at least two second wireless networks based on the comparing results in a descending order, and send connection requests to the first wireless network by using the connection information of the second wireless networks according to the order of the sorted second wireless networks until connection to the first wireless network succeeds or the connection information of all the second wireless networks have been used.

With respect to the apparatuses in the above embodiments, the specific manners for performing operations for individual modules therein have been described in detail in the embodiments regarding the methods for automatically connecting a wireless network, which will not he elaborated herein.

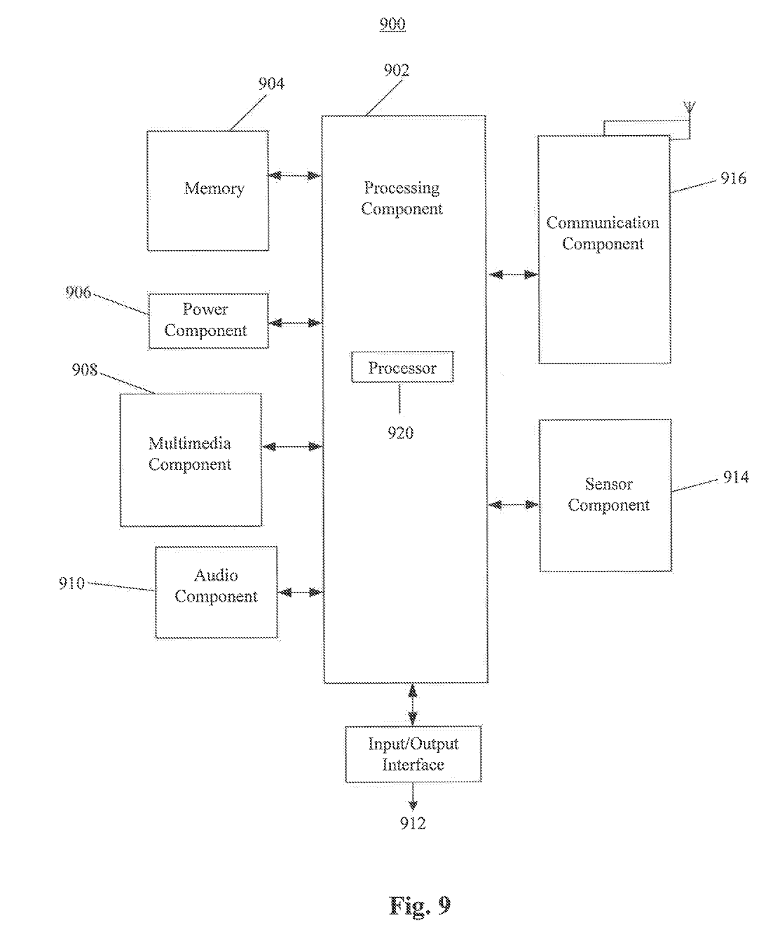

FIG. 9 is a block diagram of a terminal device 900 for connecting to a wireless network, according to an exemplary embodiment. For example, the terminal device 900 may be a mobile phone, a computer, a digital broadcast terminal, a messaging device, a gaming console, a tablet, a medical device, exercise equipment, a personal digital assistant, and the like.

Referring to FIG. 9, the terminal device 900 may include one or more of the following components: a processing component 902, a memory 904, a power component 906, a multimedia component 908, an audio component 910, an input/output (I/O) interface 912, a sensor component 914, and a communication component 916. The person skilled in the art should appreciate that the structure of the terminal device 900 as shown in FIG. 9 does not intend to limit the terminal device 900. The terminal device 900 may include more or less components or combine some components or other different components.

The processing component 902 typically controls overall operations of the terminal device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal device 900. Examples of such data include instructions for any applications or methods operated on the terminal device 900, contact data, phonebook data, messages, pictures, video, etc. The memory 904 is also configured to store programs and modules. The processing component 902 performs various functions and data processing by operating programs and modules stored in the memory 904. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 is configured to provide power to various components of the terminal device 900. The power component 906 may include a power management system, one or more power sources, and any other components associated with the generation, management, and distribution of power in the terminal device 900.

The multimedia component 908 includes a screen providing an output interface between the terminal device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures performed on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the terminal device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 may include a microphone configured to receive an external audio signal when the terminal device 900 is in an operation mode, such as a call mode, a recording mode, and/or a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the terminal device 900. For instance, the sensor component 914 may detect an on/off status of the terminal device 900, relative positioning of components, e.g., the display and the keypad, of the device 900, a change in position of the terminal device 900 or a component of the terminal device 900, a presence or absence of user contact with the device 900, an orientation or an acceleration/deceleration of the terminal device 900, and a change in temperature of the terminal device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal device 900 and other devices. The terminal device 900 can access a wireless network based on a communication standard, such as WiFi, 2G, or 3G, or a combination thereof, in one exemplary embodiment, the communication component 916 receives a broadcast signal or information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband technology, a Bluetooth (BT) technology, and/or other technologies.

In exemplary embodiments, the terminal device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 904, executable by the processor 920 in the terminal device 900, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described methods, devices, and modules/units can each be implemented through hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. The present disclosure is meant to cover any variations, usage or adaptive change of these embodiments, and these variations, usage or adaptive change follow general concept of the present disclosure and include the common knowledge or the customary technical means in the technical field that is not disclosed in the present disclosure.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to connect to a wireless network, comprising:
detecting a first wireless network when a wireless network connection of the device is in a disconnected state, wherein the first wireless network has a same name as a second wireless network, and connection information for connecting to the second wireless network is pre-stored in the device;
generating a first wireless network list including one or more wireless networks detected when the first wireless network is detected;
comparing the first wireless network list with a pre-stored second wireless network list to obtain a comparing result, wherein the second wireless network list includes one or more wireless networks previously detected when the device was connected to the second wireless network; and
if the comparing result satisfies a preset condition, sending a connection request to the first wireless network based on the connection information for connecting to the second wireless network.

2. The method according to claim 1, further comprising:
updating the second wireless network list based on the first wireless network list, if connection to the first wireless network succeeds after the connection request is sent to the first wireless network.

3. The method according to claim 2, further comprising performing at least one of adding at least one item of the first wireless network list which is not included in the second wireless network list, into the second wireless network list; or
replacing the second wireless network list with the first wireless network list.

4. The method according to claim 1, further comprising:
storing the first wireless network list when the comparing result does not satisfy the preset condition.

5. The method according to claim 1, wherein the first wireless network has a same name as at least two second wireless networks, the method further comprising:
comparing the first wireless network list with at least two pre-stored second wireless network lists to obtain at least two comparing results, respectively, wherein each of the at least two pre-stored second wireless network lists includes one or more wireless networks previously detected when the device was connected to one of the at least two second wireless networks; and
when the at least two comparing results satisfy the preset condition, sending one or more connection requests to the first wireless network by using pre-stored connection information of the at least two second wireless networks in a sequential order until connection to the first wireless network succeeds or the pre-stored connection information of each of the at least two second wireless networks has been used.

6. The method according to claim 1, wherein the first wireless network has a same name as at least two second wireless networks, the method farther comprising:
comparing the first wireless network list with at least two pre-stored second wireless network lists to obtain at least two comparing results, respectively, wherein each of the at least two second wireless network lists includes one or more wireless networks previously detected when the device was connected to one of the at least two second wireless networks;
sorting the at least two second wireless networks based on the comparing results in a descending order; and
sending one or more connection requests to the first wireless network by using pre-stored connection information of the at least two second wireless networks according to the sorted order until connection to the first wireless network succeeds or the pre-stored connection information of each of the at least two second wireless networks has been used.

7. The method according to claim 1, further comprising:
determining a number of wireless networks in the first wireless network list that each have a same name as one of the one or more wireless networks in the second wireless network list; and
determining a ratio of the number of wireless networks to a total number of the one or more wireless networks in the second wireless network list as the comparing result.

8. A device for connecting to a wireless network, comprising:
a processor; and
a memory for storing instructions executable by the processor,
wherein the processor is configured to:
detect a first wireless network when a wireless network connection of the device is in a disconnected state, wherein the first wireless network has a same name as a second wireless network, and connection information for connecting to the second wireless network is pre-stored in the device;
generate a first wireless network list including one or more wireless networks detected when the first wireless network is detected;
compare the first wireless network list with a pre-stored second wireless network list to obtain a comparing result, wherein the second wireless network list includes one or more wireless networks previously detected when the device was connected to the second wireless network; and
if the comparing result satisfies a preset condition, send a connection request to the first wireless network based on the connection information for connecting to the second wireless network.

9. The device according to claim 8, wherein the processor is further configured to:
update the second wireless network list based on the first wireless network list, if connection to the first wireless network succeeds after the connection request is sent to the first wireless network.

10. The device according to claim 9, wherein the processor is further configured to perform at least one of:
adding at least one item of the first wireless network list which is not included in the second wireless network list, into the second wireless network list; or
replacing the second wireless network list with the first wireless network list.

11. The device according to claim 8, wherein the processor is further configured to:
store the first wireless network list when the comparing result does not satisfy the preset condition.

12. The device according to claim 8, wherein the first wireless network has a same name as at least two second wireless networks, and the processor is further configured to:
compare the first wireless network list with at least two pre-stored second wireless network lists to obtain at least two comparing results, respectively, wherein each of the at least two pre-stored second wireless network lists includes one or more wireless networks previously detected when the device was connected to one of the at least two second wireless networks; and
when the at least two comparing results satisfy the preset condition, send one or more connection requests to the first wireless network by using pre-stored connection information of the at least two second wireless networks in a sequential order until connection to the first wireless network succeeds or the connection information of each of the at least two second wireless networks has been used.

13. The device according to claim 8, wherein the first wireless network has a same name as at least two second wireless networks, and the processor is further configured to:
compare the first wireless network list with at least two pre-stored second wireless network lists to obtain at least two comparing results, respectively, wherein each of the at least two pre-stored second wireless network lists includes one or more wireless networks previously detected when the device was connected to one of the at least two second wireless networks; and
sort the at least two second wireless networks based on the comparing results in a descending order; and
send one or more connection requests to the first wireless network by using pre-stored connection information of the at least two second wireless networks according to the sorted order until connection to the first wireless network succeeds or the pre-stored connection information of each of the at least two second wireless networks has been used.

14. The device according to claim 8, wherein the processor is further configured to:
determine a number of wireless networks in the first wireless network list that each have a same name as one of the one or more wireless networks in the second wireless network list; and
determine a ratio of the number of wireless networks to a total number of the one or more wireless networks in the second wireless network list as the comparing result.

15. A non-transitory computer-readable medium having stored therein instructions that, when executed by a processor of a device, cause the device to perform a method for connecting to a wireless network, the method comprising:
detecting a first wireless network when a wireless network connection of the device is in a disconnected state, wherein the first wireless network has a same name as a second wireless network, and connection information for connecting to the second wireless network is pre-stored;
generating a first wireless network list including one or more wireless networks detected when the first wireless network is detected;
comparing the first wireless network list with a pre-stored second wireless network list to obtain a comparing result, wherein the second wireless network list includes one or more wireless networks previously detected when the device was connected to the second wireless network; and
if the comparing result satisfies a preset condition, sending a connection request to the first wireless network based on the connection information for connecting to the second wireless network.

16. The non-transitory computer-readable medium according to claim 15, wherein the method further comprises:
updating the second wireless network list based on the first wireless network list, if connection to the first wireless network succeeds after the connection request is sent to the first wireless network.

17. The non-transitory computer-readable medium according to claim 16, wherein the method further comprises performing at least one of:
adding at least one item of the first wireless network list which is not included in the second wireless network list, into the second wireless network list; or
replacing the second wireless network list with the first wireless network list.

18. The non-transitory computer-readable medium according to claim 15, wherein the first wireless network has a same name as at least two second wireless networks, and the method further comprises:
comparing the first wireless network list with at least two pre-stored second wireless network lists to obtain at least two comparing results, respectively, wherein each of the at least two pre-stored second wireless network lists includes one or more wireless networks previously detected when the device was connected to one of the at least two second wireless networks; and
when the at least two comparing results satisfy the preset condition, sending one or more connection requests to the first wireless network by using the pre-stored connection information of the at least two second wireless networks in a sequential order until connection to the first wireless network succeeds or the connection information of each of the at least two second wireless networks has been used.

19. The non-transitory computer-readable medium according to claim 15, wherein the first wireless network has a same name as at least two second wireless networks, and the method further comprises:
comparing the first wireless network list with at least two pre-stored second wireless network lists to obtain at least two comparing results, respectively, wherein each of the at least two second wireless network lists includes one or more wireless networks previously detected when the device was connected to one of the at least two second wireless networks;
sorting the at least two second wireless networks based on the comparing results in a descending order; and
sending one or more connection requests to the first wireless network by using pre-stored connection information of the at least two second wireless networks according to the sorted order until connection to the first wireless network succeeds or the pre-stored connection information of each of the at least two second wireless networks has been used.

20. The non-transitory computer-readable medium according to claim 15, wherein the method further comprises;
determining a number of wireless networks in the first wireless network list that each have a same name as one of the one or more wireless networks in the second wireless network list; and
determining a ratio of the wireless networks to a total number of the one or more wireless networks in the second wireless network list as the comparing result.
